(19) United States
(12) Patent Application Publication
(10) Pub. No.: US 2004/0109096 A1
(43) Pub. Date: Jun. 10, 2004

(54) Overlay mounting system for display

(75) Inventors: Steven R. Anderson, Woodbury, MN (US); Junkang Jacob Liu, Woodbury, MN (US); Ming Cheng, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/310,448

(22) Filed: Dec. 5, 2002

(51) Int. Cl. H04N 5/72

(52) U.S. Cl. 348/832

(57) ABSTRACT

An optically transparent adhesive article for fastening the rear face of a display overlay to the front face of a display. The article includes first and second adhesive layers and an optional intervening backing layer. The first adhesive layer has sufficiently low tack so that the article is repositionable on the display of the display. The second adhesive layer has sufficient tack and the article has sufficient cohesive strength so that the article is stretch-releasable from the display overlay.

### FIELD OF THE INVENTION

This invention relates to overlays for use on electronic displays.

### BACKGROUND

Electronic displays are commonly used in devices such as laptop or desktop computers, automated teller machines and automotive instruments. These devices are sometimes equipped with a light control filter or other overlay to provide features such as enhanced privacy, glare reduction or antireflection, polarization, diffusion, tint, electromagnetic shielding, scratch or smudge resistance, slipperiness or touch sensitivity. A variety of mechanical mounts and other measures have been used to fasten such overlays to a display device. For example, a microlouvered product known as the 3M Notebook Privacy Filter is mounted on a display via a set of four protruding transparent U-shaped tabs having an adhesive stripe on one side of each tab. The tabs are adhered to the side edges of the display bezel near each corner of the display, with the rounded portion of each tab projecting inward over the front of the display. The privacy filter can be slid between the tabs and the front of the display, and removed when privacy is not needed.

Successive improvements in display technology have led to ever-narrower bezels, with ever-smaller available areas for mounting tabs or other attachments. This has made it difficult to obtain reliable mounting of privacy filters and other overlays on a display, especially when a removable overlay mounting is desired.

Various overlays are described in, for example, U.S. Pat. No. 2,524,286 (Dreyer); U.S. Pat. No. 4,652,085 (Selling et al.); U.S. Pat. No. 4,764,410 (Grzywinski); U.S. Pat. No. 4,788,597 (Gart et al.); U.S. Pat. No. 4,907,090 (Ananian); U.S. Pat. No. 5,745,288 (Miyata et al.); U.S. Pat. No. 6,059,628 (Yoo et al.); U.S. Pat. No. 6,250,765 (Murakami) and Re. 35,318 (Warman). A frame assembly for mounting on a display is shown in, for example, U.S. Pat. No. 5,549,267 (Armbruster et al.). A transparent vandal guard sheet for use on road signs is shown in, for example, U.S. Pat. No. 4,090,464 (Bishopp et al.).

Although not involving display overlays, a product known as SCOTCH™ No. 859 Clear Removable Mounting Squares provides a set of square, transparent pieces of plastic having a high-tack adhesive coating on opposing sides of the plastic squares.

### SUMMARY OF THE INVENTION

Some of the above-mentioned references show a display overlay adhered directly to the face of the display. Installation, removal and replacement of such display overlays can be frustrating, especially when the user desires to do so repeatedly. A display overlay may need to be removed, for example, to provide a brighter image in low lighting conditions, or to permit cleaning the display front viewing face or the display overlay rear face. If the overlay adhesive becomes soiled or otherwise detackified, removal and replacement of the adhesive may also be required. Adhesive removal and replacement can be difficult and time-consuming, especially when the adhesive has high tack or leaves an adhesive residue.

Some display overlay mounting systems also have appearance drawbacks. For example, a display overlay mounting system may obscure or distort a portion of the displayed image.

The present invention provides, in one aspect, an optically transparent adhesive article for fastening the rear face of a display overlay to the front face of a display, comprising first and second adhesive layers and an optional intervening backing layer wherein the first adhesive layer has sufficiently low tack so that the article is repositionable on the display and the second adhesive layer has sufficient tack and the article has sufficient cohesive strength so that the article is stretch-releasable from the display overlay.

The invention provides, in another aspect, a display overlay having a rear face that can be adhesively fastened to the front face of a display, the rear face having adhesively fastened thereto a plurality of optically transparent adhesive articles comprising first and second adhesive layers and an optional intervening backing layer wherein the first adhesive layer has sufficiently low tack so that the articles are repositionable on the display and the second adhesive layer has sufficient tack and the articles have sufficient cohesive strength so that the articles are stretch-releasable from the display overlay.

The invention provides, in yet another aspect, a display having a front viewing face adhesively fastened to the rear face of a display overlay by a plurality of optically transparent adhesive articles comprising first and second adhesive layers and an optional intervening backing layer wherein the first adhesive layer has sufficiently low tack so that the articles are repositionable on the display and the second adhesive layer has sufficient tack and the articles have sufficient cohesive strength so that the articles are stretch-releasable from the display overlay.

The invention provides, in a further aspect, a method for mounting a display overlay having a rear face onto the front face of a display, comprising adhesively fastening the rear face to the front face using a plurality of a optically transparent adhesive articles comprising first and second adhesive layers and an optional intervening backing layer wherein the first adhesive layer has sufficiently low tack so that the articles are repositionable on the display and the second adhesive layer has sufficient tack and the articles have sufficient cohesive strength so that the articles are stretch-releasable from the display overlay.

### BRIEF DESCRIPTION OF THE DRAWING

FIG. 1 is a schematic cross-sectional exploded view of an adhesive article without an intervening backing layer.

FIG. 2 is a schematic cross-sectional exploded view of an adhesive article including an intervening backing layer.

FIG. 3 is a frontal view of a computer filter adhesively mounted on a display.

FIG. 4 is a plan view of a set of adhesive articles on a precut liner.

FIG. 5 and FIG. 6 are side views showing removal of an adhesive article from the rear face of a display overlay.

Like reference symbols in the various figures of the drawing indicate like elements. The elements in the drawing are not to scale.

### DETAILED DESCRIPTION

By using words of orientation such as “atop”, “on”, “uppermost” and the like for the location of various layers in the articles of the invention, we refer to the relative position of one or more layers with respect to a horizontal reference layer corresponding to the viewing face of an upward-facing display. We do not intend by this that the adhesive articles, display overlays or displays of the invention must have any particular orientation in space during use.

Referring now to FIG. 1, adhesive article or “button” 10 includes release liner layer 12 adjacent low tack adhesive layer 14, and release liner layer 16 adjacent high tack adhesive layer 18. There is no intervening backing layer between adhesive layers 14 and 18. The high tack adhesive layer can provide a relatively firm bond to a display overlay. The low tack adhesive layer 14 can provide a repositionable bond to the viewing face of a display. The differential in adhesive tack permits preferential release of button 10 from a display (not shown in FIG. 1) so that a display overlay (also not shown in FIG. 1) can repeatedly be removed from and reapplied to the display. The low tack adhesive layer 14 preferably is non-tacky at room temperature, thereby reducing the likelihood that contaminants will compromise the bonding ability of button 10. More preferably the low tack adhesive layer 14 is washable with water or another suitable fluid to remove minor contaminants and restore the adhesive layer 14 to a tacky state. These preferred low tack and washability features provide increased button longevity compared to buttons having tackier or non-washable adhesives.

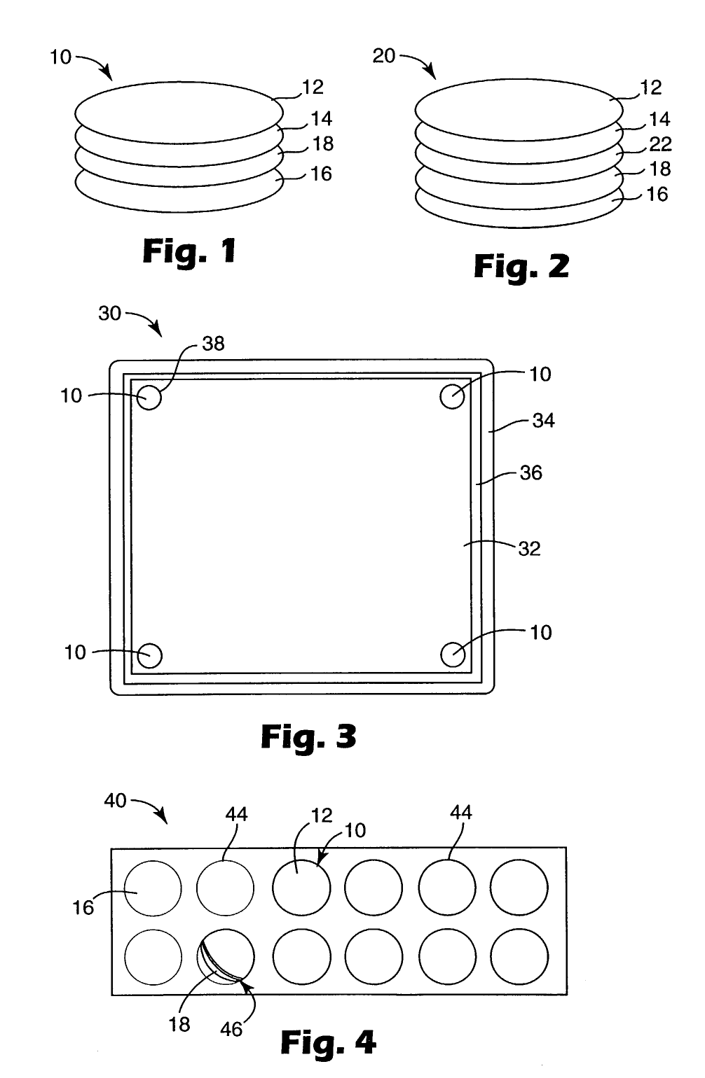

FIG. 2 shows button 20 in which adhesive layers 14 and 18 are separated by an intervening transparent stretchable backing layer 22 and respectively covered by liners 12 and 16. Backing layer 22 increases the cohesive strength of button 20 and permits use of thinner adhesive layers, but is sufficiently extensible to permit stretch release of button 20 from a display as described in more detail below.

FIG. 3 shows a display assembly 30 in which buttons 10 are adhesively fastened (by high tack adhesive layer 18, not shown in FIG. 3) to the rear face of computer filter 32. Buttons 10 are also adhesively fastened (by low tack adhesive layer 14, not shown in FIG. 3) to the viewing face of liquid crystal display (“LCD”) 34. Buttons 10 are transparent, small in size and located near the corners of filter 32 and bezel 36. Under some lighting or viewing conditions, the circumference 38 of button 10 may be faintly visible. Buttons 10 preferably are relatively unobtrusive and preferably do not detract from the appearance of display 34.

FIG. 4 shows a sheet 40 designed to hold an array of twelve buttons 10. Buttons 10 are defined by circular kiss-cuts 44 that penetrate through release liner 12, low tack adhesive layer 14, high tack adhesive layer 18 and optionally into the upper surface of release liner 16, without penetrating through release liner 16. Three buttons (not shown in FIG. 4) have already been removed from sheet 40. Button 46 has been partially peeled away from sheet 40. Eight additional buttons 10 remain fully adhered to sheet 40. Removal of buttons 10 from sheet 40 can be facilitated by flexing release liner 16 away from high tack adhesive layer 18 on buttons 10.

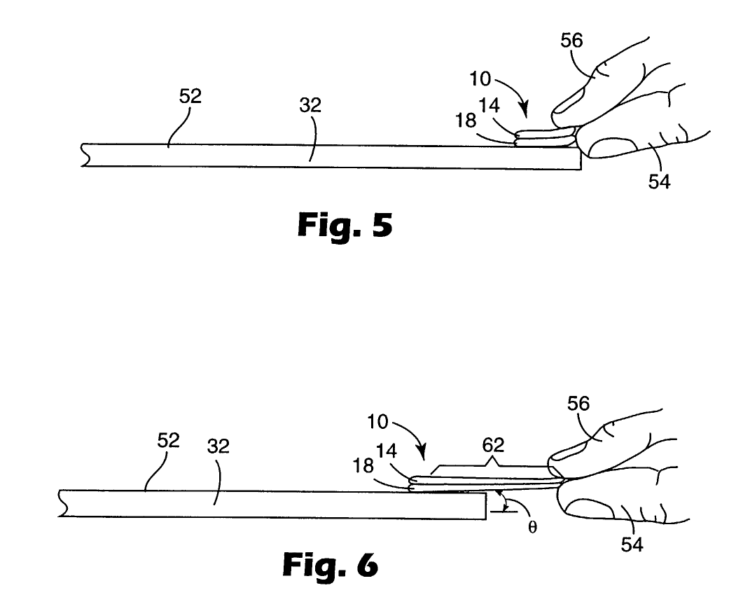

FIG. 5 and FIG. 6 show removal of button 10 from display overlay 32. High tack adhesive layer 18 has been adhered to the rear face 52 of color filter 32. A user's thumb 54 and index finger 56 grasp and slightly lift a portion of button 10 away from face 52. In FIG. 6, button 10 has been pulled away from face 52 at a narrow angle θ, causing elongated portion 62 to lose adhesion to face 52 as portion 62 stretches away from face 52. By applying a firm, steady pull on button 10, complete removal of button 10 preferably can be accomplished without leaving residue from high tack adhesive layer 18 on face 52.

Adhesive articles such as button 10 can readily be made in continuous fashion. As an example, adhesive layers 14 and 18 can be extruded onto liner 16 in one or two passes followed by application of liner 12 to adhesive layer 14. Also, adhesive layer 14 can be extruded onto liner 12, adhesive layer 18 can be extruded onto liner 16, and the resulting two assemblies can be laminated together by mating adhesive layers 14 and 18. The completed assembly preferably is partially die cut through one liner layer 12 or 16 and both adhesive layers 14 and 18 to define the buttons 10.

An adhesive article such as button 20 can also be made in continuous fashion, e.g., by extruding adhesive layers 14 and 18 onto backing layer 22 followed by application of liner 12 to adhesive layer 14 and liner 16 to adhesive layer 18. The resulting assembly can be partially die cut as outlined above.

The high tack adhesive and low tack adhesive can be made from a variety of materials. Preferably both the high tack and low tack adhesive are optically clear and have low odor. Preferably at least the low tack adhesive and more preferably both the low tack and high tack adhesive are free of acidic functional groups such as are present in pressure sensitive adhesives derived from acrylic acid. As shown below, adhesives containing such acidic functional groups can cause corrosion of an indium tin oxide layer, and potentially may damage one or more layers in a touch-sensitive panel, LCD or other information display.

A variety of adhesives can be employed in the invention, including silicones, synthetic block copolymers and acrylic adhesives. Preferred high tack adhesives include the stretch-releasable adhesives described in U.S. Pat. No. 5,409,189 (Lühmann '189), U.S. Pat. No. 5,491,012 (Lühmann et al.), U.S. Pat. No. 5,516,581 (Kreckel et al.), U.S. Pat. No. 5,725,923 (Lühmann '923), U.S. Pat. No. 6,004,642 (Langford), U.S. Pat. No. 6,120,867 (Hamerski et al.), U.S. Pat. No. 6,162,534 (Hamerski) and published PCT Application No. WO 01/34717, and the tackified synthetic block copolymer elastomers described in U.S. Pat. No. 3,239,478 (Harlan), U.S. Pat. No. 3,917,607 (Crossland et al.), U.S. Pat. No. 3,932,328 (Korpman), U.S. Pat. No. 4,125,665 (Bemmels et al.), U.S. Pat. No. 4,444,953 (St. Clair '953), U.S. Pat. No. 4,556,464 (St. Clair '464), U.S. Pat. No. 4,699,938 (Minamizaki et al.), U.S. Pat. No. 4,780,367 (Lau), U.S. Pat. No. 5,393,787 (Nestegard et al. '787), U.S. Pat. No. 5,342,858 (Litchholt et al.) and U.S. Pat. No. 5,773,506 (Nestegard et al. '506). Most preferably the high tack adhesive is formed from a tackified synthetic block copolymer, with the amount of tackifier being adjusted to provide the desired degree of tack. Preferred tackifiers for use in such synthetic block copolymers include, for example, coumarone indenes, rosin esters, aromatic resins, mixed aromatic/aliphatic resins, aromatic modified hydrocarbon resins, liquid hydrocarbon resins, liquid polyterpenes, liquid rosin esters and liquid polystyrene resins. The tackifier amount in such preferred adhesives desirably is adjusted to a level sufficient to permit removal of the display overlay from the face of a display without causing separation of the adhesive bond to the display overlay rear face, and to permit easy stretch-release removal of the button by hand from the display overlay rear face without leaving an adhesive residue. Tackifier amounts of about 20% to about 60% tackifier, more preferably about 30 to about 50% are preferred in such high tack adhesives.

Preferred low tack adhesives include tackified synthetic block copolymer elastomers such as those described in the preceding paragraph, but with generally lower tackifier levels. The tackifier amount in such preferred low tack adhesives desirably is adjusted to a level so that the display overlay will be firmly held in place on the face of the display at the desired use temperatures, while still permitting repeated removal and reattachment (“repositionability”) of the display overlay on a display when desired. For example, when the display overlay is a privacy filter, a repositionability feature enables the privacy filter to be removed so that a user can share displayed information with other viewers, and reattached so that the information is no longer shared. Removal typically is carried out by using an appropriate peeling motion to flex the display overlay away from the face of the display. The tackifier amount in such preferred low tack adhesives also preferably is adjusted to a level such that the button will not pick up dust, lint or other contaminants that might contact the low tack adhesive side of the button when the low tack adhesive is not in contact with the face of a display. For example, the display overlay might contact paper or other surfaces during storage. Preferably the low tack adhesive can be washed, e.g. with water or another suitable fluid to remove loosely bound contaminants that might become affixed to the low tack adhesive during such storage and reactivate the adhesive. Tackifier amounts of about 5% to about 20% tackifier are preferred in such low tack adhesives.

The extent of adhesive tackiness can be adjusted in a variety of ways. Such adjustment can permit formation of the low tack adhesive and high tack adhesive using similar materials. For example, in a radiation-crosslinked (e.g., e-beam crosslinked) adhesive, the amount of crosslinking irradiation can be adjusted to change the degree of tack Also, a low tack adhesive can be formed from a high tack adhesive whose surface has been selectively detackified. A variety of such surface detackification techniques can be employed. For example, all or a portion of the adhesive surface can be dusted with talc or another suitable solid material.

The optional backing layer can be made from a variety of materials. A preferred material is an optically clear plastic film such as polyethylene terephthalate (“PET”), primed on both sides to increase its bond to each adhesive. The backing layer preferably is relatively thin in order to maximize its transmittance and facilitate stretch-release. Backing layer thicknesses of about 0.05 to about 0.25 mm are preferred. If desired, the backing layer can include an uncoated tab portion to facilitate application or removal of the button.

The shape and size of the buttons can be varied. Round buttons with a diameter of about 5 mm to about 15 mm are preferred for use on typical display overlays. Other button shapes and sizes can be used as desired, e.g., strips or squares. Typically, one button will be placed in each corner of a polygonal display overlay. Typically, a plurality of buttons will be spaced at scattered locations around the perimeter of a circular or other non-polygonal display overlay. Buttons prepared without an optional backing layer preferably have high tack and low tack adhesive layer thicknesses of about 0.01 to about 0.25 mm, more preferably about 0.1 to about 0.2 mm. Buttons prepared with an optional backing layer preferably have high tack and low tack adhesive layer thicknesses of about 0.01 to about 0.13 mm, more preferably about 0.03 to about 0.08 mm.

The adhesive articles of the invention can be used with a wide variety of display overlays. Such display overlays include flexible overlays (e.g., thin films made of a suitable plastic material) and rigid overlays (e.g., panels made of glass or a suitable plastic material). The display overlay can be unframed or can be equipped with a frame or other bezel. Representative display overlays include microlouvered privacy filters, antireflection films, polarizing films, diffusers, colored filters, electromagnetic shields, scratch or smudge resistant films, low surface energy films and touch-sensitive panels.

The adhesive articles and display overlays of the invention can be used on a wide variety of information displays. Such displays include multi-character and especially multi-line displays such as LCDs, plasma displays, electroluminescent displays, front and rear projection displays, cathode ray tubes (“CRTs”) and signage. The adhesive articles and display overlays of the invention can also be used on single-pixel or binary displays such as individual light emitting diodes (“LEDs”), signal lamps and switches. The adhesive articles and display overlays can be used on illuminated or non-illuminated displays. The invention has particular utility for displays whose information display area is in the form of a viewing screen having a viewing surface that is susceptible to damage during normal use.

The invention can be used in a variety of portable and non-portable information display devices including notebook computer displays, computer monitors, personal digital assistants (“PDAs”), cell phones (including combination PDA/cell phones), touch-sensitive screens, wrist watches, car navigation systems, global positioning systems, depth finders, calculators, electronic books, CD or DVD players, televisions (e.g., projection televisions), instrument gauges, instrument panel covers, signage such as graphic displays (including indoor and outdoor graphics, bumper stickers, and the like), and reflective sheeting. These information display devices can have planar viewing faces or non-planar viewing faces (e.g., the curved face of a typical CRT). Usually the display overlay will be positioned on the viewing face of the information display device so that it overlies or substantially overlies all of the information display area.

The invention thus may facilitate installation, removal or replacement of display overlays on a display. The low tack first adhesive layer may help a user repositionably align the display overlay on the display viewing face. The stretch-releasable second adhesive layer may help a user remove the adhesive articles from the display overlay without leaving an adhesive residue. The adhesive articles may have an unobtrusive appearance that may reduce the extent to which a displayed image is distorted or obscured. If soiled, preferred embodiments of the invention may be washed with water to reactivate the adhesive.

The properties of articles of the invention are further illustrated in the following examples. Unless otherwise indicated, all parts and percentages are by weight. 180° peel adhesion testing was performed on a variety of substrates using a test method similar to ASTM D 3330-90, but substituting the chosen substrates for the stainless steel substrate employed in the ASTM test method. Adhesive coatings on PET film were cut into 19 mm by 102 mm strips. Each strip was adhered to a 51 mm by 102 mm substrate that had been washed with methylethyl ketone. A 2-kilogram roller was passed once over the strip, and the bond was allowed to remain at room temperature for 10 minutes. 180° peel adhesion values were measured using a Model M90 slip/peel tester (commercially available from Instrumentors Inc., Strongsville, Ohio) operated at a rate of 286 mm/minute over a five second data collection time. The reported peel adhesion values were an average of two samples on each substrate.

### EXAMPLE 1

60 Parts of KRATON™ D1107 S-I-S block copolymer (copolymer having polystyrene endblocks and a rubbery polyisoprene midblock, commercially available from Kraton Polymers) and 40 parts of WINGTACK™ 95 tackifier (aliphatic C-5 petroleum hydrocarbon resin, commercially available from Goodyear Chemical) were dissolved in 186 parts of toluene to form a 35% solids solution of a high tack adhesive. 90 Parts of KRATON D1107 copolymer and 10 parts of WINGTACK 95 tackifier were dissolved in 186 parts of toluene to form a 35% solids solution of a low tack adhesive. These tackified elastomers do not contain acids, and thus have a reduced tendency to damage acid sensitive coatings on an LCD screen. The adhesives were hand-spread on separate release liners using a knife coater, then dried for 5 minutes in a 70° C. oven. The dried films were laminated together, adhesive to adhesive, by passing them through a roll laminator at 110° C. The resulting assembly was die-cut into 11 mm diameter buttons.

The liners were removed from the high tack side of four buttons and pressed onto the rear face of a Model PF-14.1 privacy filter (commercially available from 3M). The liners were removed from the low tack side of the buttons and the privacy filter was removably adhered to the front face of LCD panels sold by IBM, Phillips and Samsung. The privacy filter could be repeatedly removed from and replaced on the LCD panels, and repositioned as desired. When the filter was removed, the buttons resisted contamination by dust, debris and other minor contaminants. The buttons could be washed with water and slung dry or lightly patted dry using a paper towel or low-lint tissue. The buttons could also be permanently removed from the rear face of the privacy filter by stretching the buttons at a narrow included angle with respect to the filter, whereupon the high tack side of the adhesive cleanly released from the rear face of the filter.

### EXAMPLE 2

The low tack adhesive solution of Example 1 was hand-spread on a 2 mil double primed MELINEX™ PET film (commercially available from E. I. duPont de Nemours & Co.) using a knife coater. The film was dried for 5 minutes in a 70° C. oven. A liner was laminated to the top of exposed adhesive. Next, the high tack adhesive solution of Example 1 (60 Parts of KRATON D1107 copolymer and 40 parts of WINGTACK 95 tackifier) was hand-spread on the other side of the PET film using a knife coater. The film was dried for 5 minutes in a 70° C. oven and a liner was laminated to the top of the exposed adhesive. The final assembly was die-cut into 11 mm diameter buttons.

The buttons could be adhered to a privacy filter, repeatedly removed from and replaced on a laptop screen, repositioned as desired and washed to remove contaminants as in Example 1. The buttons could also be permanently removed from the rear face of the privacy filter by stretching the buttons at a narrow included angle with respect to the filter, whereupon the high tack side of the adhesive cleanly released from the rear face of the filter.

### EXAMPLE 3

60 Parts of KRATON D1107 copolymer and 40 parts of REGALITE™ R1125 tackifier (hydrogenated hydrocarbon resin, commercially available from Eastman Chemical Company) were dissolved in 186 parts of toluene to form a 35% solids solution of a high tack adhesive. The solution was coated on 0.05 mm PET film using a knife coater with the gap controlled to provide a 0.6 mm thick wet coating. The coated adhesive was dried at 70° C. for 10 minutes to provide a pressure sensitive high tack adhesive film having a thickness of 0.2 mm. 90 Parts of KRATON D1107 copolymer and 10 parts of REGALITE R1125 tackifier were dissolved in 186 parts of toluene to form a 35% solids solution of a low tack adhesive. The solution was coated on 0.05 mm PET film using a knife coater with the gap controlled to provide a 0.6 mm thick wet coating. The coated adhesive was dried at 70° C. for 10 minutes to provide a pressure sensitive low tack adhesive film having a thickness of 0.2 mm.

### EXAMPLE 4

Using the method of Example 3, high tack and low tack adhesive films were formed by substituting WINGTACK 95 tackifier for REGALITE R1125 tackifier.

### EXAMPLE 5

Using the method of Example 3, a high tack adhesive film was formed by combining 70 parts of KRATON™ G1657 copolymer (hydrogenated styrene-butadiene block copolymer elastomer, commercially available from Kraton Polymers) and 30 parts REGALITE R1125 tackifier, dissolving the resulting mixture in 186 parts of toluene to form a 35% solids solution, and coating and drying the solution on 0.05 mm PET.

The adhesives of Examples 3-5 were evaluated for 180° peel adhesion on various substrates. Set out below in Table 1 are the 180° peel adhesion results on glass, polypropylene (PP), polycarbonate (PC) and PET.

TABLE 1

180° Peel Adhesion
on Substrate (Kg/m)

| Example | glass | PP | PC | PET |
|---|---|---|---|---|
| 1, high tack | 11.9 | 22.9 | 92.2 | 58.5 |
| 1, low tack | 7.3 | 1.9 | 66.6 | 35.0 |
| 3, high tack | 39.2 | 108.5 | 101.6 | 55.2 |
| 4, low tack | 45.1 | 44.1 | 90.1 | 30.0 |
| 5 | 0.9 | 1.3 | 14.2 | 6.3 |

The results in Table 1 show a range of low tack and high tack adhesion values. All of the adhesives released cleanly from the tested substrates. The adhesive of Example 5 and the low tack adhesives of Examples 1 and 4 could be repositionably adhered to polypropylene and glass. The high tack adhesives of Examples 1 and 3 could be stretch-released from all substrates.

### EXAMPLE 6

100 Parts of No. DMS-A32 polydimethylsilane diamine (commercially available from Gelest, Inc.) were degassed at 100° C. under reduced pressure to remove absorbed carbon dioxide. The degassed diamine and 50 parts of DYTEK™ A amine resin (commercially available from E. I. duPont de Nemours and Co.) were dissolved into a 70:30 mixture of toluene: 2-propanol. 150 Parts of 4,4′-methylene bis(cyclohexyl isocyanate) (commercially available from Aldrich) were added to the solution followed by stirring for two hours at room temperature. 300 Parts of No. SST-3M01 sol-gel-derived hybrid inorganic-organic MQ resin (commercially available from Gelest, Inc.) were dissolved into the above solution to give a silicone polyurea elastomer adhesive solution containing 30% solids. The adhesive solution was labeled “SPU Elastomer Solution 1”.

300 Parts of No. DMS-A32 polydimethylsilane diamine were degassed at 100° C. under reduced pressure to remove absorbed carbon dioxide. The degassed diamine was dissolved into a 70:30 mixture of toluene: 2-propanol. 300 Parts of 4,4′-methylene bis(cyclohexyl isocyanate) were added to the solution followed by stirring for two hours at room temperature to give a silicone polyurea elastomer adhesive solution containing 30% solids. The adhesive solution was labeled “SPU Elastomer Solution 2”.

### EXAMPLE 7

20 Parts of SPU Elastomer Solution 1 were mixed with 80 parts of SPU Elastomer Solution 2 at room temperature. The resulting mixture was coated on 0.05 mm PET film and dried using the method of Example 3.

### EXAMPLE 8

40 Parts of SPU Elastomer Solution 1 were mixed with 60 parts of SPU Elastomer Solution 2 at room temperature. The resulting mixture was coated on 0.05 mm PET film and dried using the method of Example 3.

### EXAMPLE 9

60 Parts of SPU Elastomer Solution 1 were mixed with 40 parts of SPU Elastomer Solution 2 at room temperature. The resulting mixture was coated on 0.05 mm PET film and dried using the method of Example 3.

### EXAMPLE 10

SPU Elastomer Solution 1 was coated on 0.05 mm PET film and dried using the method of Example 3.

The adhesives of Examples 7-10 were evaluated for 180° peel adhesion on various substrates. Set out below in Table 2 are the 180° peel adhesion results on glass, PP, PC and PET.

TABLE 2

180° Peel Adhesion
on Substrate (Kg/m)

| Example | glass | PP | PC | PET |
|---|---|---|---|---|
| 7 | 1.3 | 1.0 | 1.3 | 1.2 |
| 8 | 7.5 | 4.3 | 6.7 | 4.6 |
| 9 | 24.7 | 14.5 | 26.5 | 13.9 |
| 10 | 57.5 | 46.5 | 58.9 | 7.6 |

Examples 7 and 8 show a range of low tack adhesion values. All of the adhesives released cleanly from the tested substrates. The adhesives of Examples 7 and 8 could be repositionably adhered to all the tested substrates.

### EXAMPLE 11

80 Parts of No. DMS-V46 vinyl terminated polydimethylsilane (commercially available from Gelest, Inc.) and 20 parts of No. SST-3M01 sol-gel-derived hybrid inorganic-organic MQ resin were dissolved in toluene. Sufficient SYL-OFF™ 7678 silicone crosslinker (commercially available from Dow Corning) to provide a 2:1 ratio of hydride to vinyl groups, 200 ppm of dimethyl maleate (commercially available from Aldrich) as an inhibitor and 50 ppm of No. SIP6832.0 platinum catalyst (commercially available from Gelest, Inc.) were added to the solution to provide 25% solids. The solution was coated on 0.05 mm PET film using a knife coater with the gap controlled to provide a 0.6 mm thick wet coating. The coated adhesive was dried at 70° C. for 10 minutes and then heated to 110° C. for another 10 minutes to provide a pressure sensitive adhesive film having a thickness of 0.15 mm.

### EXAMPLE 12

Using the method of Example 11, 60 parts of vinyl terminated polydimethylsilane and 40 parts of sol-gel-derived hybrid inorganic-organic MQ resin were dissolved in toluene and then combined with SYL-OFF™ 7678 silicone crosslinker, dimethyl maleate and platinum catalyst at a 25% solids level. The solution was coated on 0.05 mm PET film and dried using the method of Example 11.

### EXAMPLE 13

Using the method of Example 11, 40 parts of vinyl terminated polydimethylsilane and 60 parts of sol-gel-derived hybrid inorganic-organic MQ resin were dissolved in toluene and then combined with SYL-OFF™ 7678 silicone crosslinker, dimethyl maleate and platinum catalyst at a 25% solids level. The solution was coated on 0.05 mm PET film and dried using the method of Example 11.

The adhesives of Examples 11-13 were evaluated for 180° peel adhesion on various substrates. Set out below in Table 3 are the 180° peel adhesion results on glass, PP and PET.

TABLE 3

180° Peel Adhesion
on Substrate(Kg/m)

| Example | glass | PP | PET |
|---|---|---|---|
| 11 | 0.0 | 0.4 | 0.0 |
| 12 | 1.1 | 0.8 | 0.6 |
| 13 | 66.7 | 41.2 | 2.6 |

The results in Table 3 show a range of low tack and high tack adhesion values. All of the adhesives released cleanly from the tested substrates. The adhesive of Example 11 could be repositionably adhered to polypropylene and the adhesive of Example 12 could be repositionably adhered to glass, polypropylene and PET. The adhesive of Example 13 could be stretch-released from all substrates.

### EXAMPLE 14

76 mm by 76 mm indium tin oxide (ITO)-coated PET panels (commercially available from 3M Touch Systems) were laminated to a variety of adhesives. Conductivity measurements were made on three samples of each panel before and after lamination, and following aging for 2 hours, 24 hours and five days in a 60° C., 65 percent relative humidity oven. Set out below in Table 4 are the identity of each adhesive, the measured conductivity values and the percent change in conductivity at 24 hours and 5 days.

TABLE 4

| | Conductivity(Ohms) | | | | |
|---|---|---|---|---|---|
| | | | | 24 Hrs | |
| | | | | (% | |
| | | Post- | | change | 5 Days (% |
| | | La- | | from | change from |
| Adhesive | Initial | mination | 2 Hrs | Initial) | Initial) |
| 50/50 IOA/AA tape¹ | 405 | 438 | 424 | 517 (27.7) | 1021 (152.1) |
| 90/10 IOA/AA tape² | 384 | 391 | 386 | 406 (5.7) | 482 (25.5) |
| 95/5 IOA/AA tape³ | 355 | 370 | 382 | 427 (20.3) | 665 (87.3) |
| 3M No. 9425 tape⁴ | 415 | 517 | 416 | 517 (24.6) | 1041 (150.8) |
| Example 3 low tack | 373 | 378 | 383 | 383 (2.7) | 383 (2.7) |
| tape⁵ | | | | | |
| Control | 434 | — | 452 | 445 (2.5) | 428 (−1.4) |

¹Adhesive prepared according to U.S. Pat. No. 5,804,610 and PCT Published Application No. WO 00/56828.
²No. 8161 tape (commercially available from 3M).
³No. 845 tape (commercially available from 3M).
⁴A double-sided tape (commercially available from 3M), adhered to the high tack (No. 400 adhesive) side.
⁵Adhesive containing 10% tackifier.

The results in Table 4 show that an acid-free adhesive exhibited a greatly reduced tendency to alter the resistance of an ITO-coated panel.

Various modifications and alterations of this invention will be apparent to those skilled in the art without departing from this invention. This invention should not be restricted to that which has been set forth herein only for illustrative purposes.

We claim:

1. An optically transparent adhesive article for fastening the rear face of a display overlay to the front face of a display, comprising first and second adhesive layers and an optional intervening backing layer wherein the first adhesive layer has sufficiently low tack so that the article is repositionable on the display and the second adhesive layer has sufficient tack and the article has sufficient cohesive strength so that the article is stretch-releasable from the display overlay.

2. An article according to claim 1 wherein the adhesion of the first adhesive layer to a display is less than the adhesion of the second adhesive layer to a display overlay.

3. An article according to claim 1 wherein the first or second adhesive comprises a crosslinked acrylic.

4. An article according to claim 1 wherein the first or second adhesive comprises a silicone.

5. An article according to claim 1 wherein the first or second adhesive comprises a synthetic block copolymer.

6. An article according to claim 1 wherein the first and second adhesives comprise a tackified synthetic block copolymer.

7. An article according to claim 1 wherein the first adhesive is substantially acid- free.

8. An article according to claim 1 wherein both the first and second adhesives are substantially acid-free.

9. An article according to claim 1 comprising a backing layer.

10. An article according to claim 9 wherein the backing layer comprises an uncoated tab portion.

11. An article according to claim 1 wherein the first adhesive can be washed with water to remove minor contaminants from the first adhesive and leave it in a tacky state.

12. An article according to claim 1 further comprising at least one release liner on an adhesive layer.

13. A display overlay having a rear face that can be adhesively fastened to the front face of a display, the rear face having adhesively fastened thereto a plurality of optically transparent adhesive articles comprising first and second adhesive layers and an optional intervening backing layer wherein the first adhesive layer has sufficiently low tack so that the articles are repositionable on the display and the second adhesive layer has sufficient tack and the articles have sufficient cohesive strength so that the articles are stretch-releasable from the display overlay.

14. A display overlay according to claim 13 wherein the adhesion of the first adhesive layer to a display is less than the adhesion of the second adhesive layer to the display overlay.

15. A display overlay according to claim 13 wherein the first or second adhesive comprises a crosslinked acrylic.

16. A display overlay according to claim 13 wherein the first or second adhesive comprises a silicone.

17. A display overlay according to claim 13 wherein the first or second adhesive comprises a synthetic block copolymer.

18. A display overlay according to claim 13 wherein the first and second adhesives comprise a tackified synthetic block copolymer.

19. A display overlay according to claim 13 wherein the first adhesive is substantially acid-free.

20. A display overlay according to claim 13 wherein the first and second adhesives are substantially acid-free.

21. A display overlay according to claim 13 wherein the articles comprise the intervening backing layer.

22. A display overlay according to claim 21 wherein the backing layer comprises an uncoated tab portion.

23. A display overlay according to claim 13 wherein the first adhesive can be washed with water to remove minor contaminants from the first adhesive and leave it in a tacky state.

24. A display overlay according to claim 13 further comprising at least one release liner on the first adhesive layer.

25. A display having a front viewing face adhesively fastened to the rear face of a display overlay by a plurality of optically transparent adhesive articles comprising first and second adhesive layers and an optional intervening backing layer wherein the first adhesive layer has sufficiently low tack so that the articles are repositionable on the display and the second adhesive layer has sufficient tack and the articles have sufficient cohesive strength so that the articles are stretch- releasable from the display overlay.

26. A display according to claim 25 wherein the adhesion of the first adhesive layer to the display is less than the adhesion of the second adhesive layer to the display overlay.

27. A display according to claim 25 wherein the first or second adhesive comprises a crosslinked acrylic.

28. A display according to claim 25 wherein the first or second adhesive comprises a silicone.

29. A display according to claim 25 wherein the first or second adhesive comprises a synthetic block copolymer.

30. A display according to claim 25 wherein the first and second adhesives comprise a tackified synthetic block copolymer.

31. A display according to claim 25 wherein the first adhesive is substantially acid- free.

32. A display according to claim 25 wherein the first and second adhesives are substantially acid-free.

33. A display according to claim 25 wherein the articles comprise the intervening backing layer.

34. A display according to claim 33 wherein the backing layer comprises an uncoated tab portion.

35. A display according to claim 25 wherein the first adhesive can be washed with water to remove minor contaminants from the first adhesive and leave it in a tacky state.

36. A method for mounting a display overlay having a rear face onto the front face of a display, comprising adhesively fastening the rear face to the front face using a plurality of a optically transparent adhesive articles comprising first and second adhesive layers and an optional intervening backing layer wherein the first adhesive layer has sufficiently low tack so that the articles are repositionable on the display and the second adhesive layer has sufficient tack and the articles have sufficient cohesive strength so that the articles are stretch-releasable from the display overlay.

37. A method according to claim 36 wherein the adhesion of the first adhesive layer to the display is less than the adhesion of the second adhesive layer to the display overlay.

38. A method according to claim 36 wherein the first or second adhesive comprises a crosslinked acrylic.

39. A method according to claim 36 wherein the first or second adhesive comprises a silicone.

40. A method according to claim 36 wherein the first or second adhesive comprises a synthetic block copolymer.

41. A method according to claim 36 wherein the first and second adhesives comprise a tackified synthetic block copolymer.

42. A method according to claim 36 wherein the first adhesive is substantially acid-free.

43. A method according to claim 36 wherein the first and second adhesives are substantially acid-free.

44. A method according to claim 36 wherein the articles comprise the intervening backing layer.

45. A method according to claim 44 wherein the backing layer comprises an uncoated tab portion.

46. A method according to claim 36 wherein the first adhesive can be washed with water to remove minor contaminants from the first adhesive and leave it in a tacky state.
